(19) United States
(12) Patent Application Publication
(10) Pub. No.: US 2010/0204966 A1
(43) Pub. Date: Aug. 12, 2010

(54) VARIABLE DECIDING METHOD, VARIABLE DECIDING DEVICE, PROGRAM AND RECORDING MEDIUM

(76) Inventors: Manabu Kano, Kyoto (JP); Koichi Fujiwara, Kyoto (JP)

Correspondence Address: Muncy, Geissler, Olds & Lowe, PLLC, 4000 Legato Road, Suite 310, FAIRFAX, VA, 22033, US

(21) Appl. No.: 12/302,477

(22) PCT Filed: May 29, 2007
(86) PCT No.: PCT/JP2007/060862

§ 371 Date: Nov. 25, 2008

(30) Foreign Application Priority Data
May 29, 2006 (JP) 2006-148874

(51) Int. Cl. G06F 17/10

(52) U.S. Cl. 703/2

(57) ABSTRACT

Provided are a variable deciding method, a variable deciding device, a program and a recording medium with which model construction using time information appropriately can be achieved and prediction performance can be improved. The variable deciding device accepts an operation variable uᵢ after batch process operation (step S21). A wavelet coefficient for said read operation variable uᵢ is then computed (step S24). Selection means selects a wavelet coefficient which satisfies a predetermined condition from computed wavelet coefficients (step S25). The wavelet coefficient selected in such a manner is then outputted by output means as a value associated with an operation variable to be inputted.

### TECHNICAL FIELD

The present invention relates to: a variable deciding method for deciding an operation variable to be inputted into a model formula which expresses a batch process to be operated according to an operation variable; a variable deciding device; and a program and a recording medium for causing said variable deciding device to function as a computer.

### BACKGROUND ART

As the life cycle of products shortens, a critical issue in a variety of industries these days is improvement of the product quality or the yield in a short time. It is anticipated that a batch process further continues to gain in importance while the industry shifts to diversified low-volume manufacturing of high-value-added products. The feature of a batch process is that an unsteady operation is performed. That is, a process is operated according to a preset operation variable. Accordingly, an essential technology for realizing a high level of competitiveness is optimization of an operation variable for the purpose of improvement of the quality or the yield.

For improving the product quality, it is necessary to associate the quality with the operating condition. Accordingly, a quality model for predicting the quality from an operating condition plays an important role. Suggested conventionally is a method of quality model construction and operating condition optimization based on an multivariate analysis such as PCR (Principal Component Regression) or PLS (Partial Least Squares) (see Non Patent Literatures 1 to 3, for example).

Moreover, it is necessary to associate an operation variable with the quality when a batch process is targeted. Since modeling thereof is generally difficult, suggested as a statistical model construction method for an input of an operation variable is Multiway PCA (Principal Component Analysis) based on PCA, Multiway PLS based on PLS, or the like (see Non Patent Literatures 4 and 5, for example).

[Non Patent Literature 1] C. M. Jaeckle and J. F. MacGregor: Product Design through Multivariate Statistical Analysis of Process Data, AIChE J., 44, 1105/1118 (1998)

[Non Patent Literature 2] M. Kano, K. Fujiwara, S. Hasebe, and H. Ohno: Data Driven Quality Improvement: Handling Qualitative Variables, IFAC Symp. On Dynamics and Control of Process System (DYCOPS), CD-ROM, Cambridge, Jul. 5-7 (2004)

[Non Patent Literature 3] Kano, Fujiwara, Hasebe, and Ohno: Quantification of Qualitative Quality Information for Quality Improvement based on Operating Data, Collection of Papers from Society of Instrument and Control Engineers (2006)

[Non Patent Literature 4] P. Nomikos and J. F. MacGregor: Monitoring Batch Process Using Multiway Principal Component Analysis, AIChE J., 40, 1361/1375 (1994)

[Non Patent Literature 5] P. Nomikos and J. F. MacGregor: Multiway Pertial Least Squares in Monitoring Batch Processes, Chemometrics and Intelligent laboratory Systems, 30, 97/109 (1995)

### DISCLOSURE OF INVENTION

### Technical Problem

However, with the methods disclosed in Non Patent Literatures 1 to 5 wherein all of variables measured at different times are treated as input variables, the number of input variables may possibly increase, causing reduction of estimate accuracy of a model. Moreover, timing of operations has a great influence on quality in a batch process. However, since time information cannot be extracted properly in a multivariate analysis, there is a problem that construction of a statistical model for an input of an operation variable is difficult.

The present invention has been made in view of such a situation. An object of the present invention is to provide: a variable deciding method for computing wavelet coefficients for an operation variable after batch process operation, selecting a wavelet coefficient, which satisfies a predetermined condition, therefrom and outputting the selected wavelet coefficient so as to enable model construction, which reflects time information, and improvement of prediction performance; a variable deciding device; and a program and a recording medium for causing a computer to function as a variable deciding device.

### Solution to Problem

A variable deciding method according to the present invention is a variable deciding method for deciding an operation variable to be inputted into a model formula which expresses a batch process to be operated according to an operation variable, characterized by comprising: an acceptance step of accepting an operation variable after batch process operation from an input unit; a computation step of computing, with a control unit, a wavelet coefficient for the operation variable accepted in the acceptance step; a selection step of selecting, with the control unit, a wavelet coefficient which satisfies a predetermined condition from wavelet coefficients computed in the computation step; and an output step of outputting, with the control unit, the wavelet coefficient selected in the selection step as a value associated with an operation variable to be inputted into a model formula which expresses a batch process.

A variable deciding method according to the present invention is characterized by further comprising: an optimum wavelet coefficient value computing step of inputting, with the control unit, the selected wavelet coefficient outputted in the output step into a model formula and computing, with the control unit, a value of a wavelet coefficient which gives an optimum evaluated value of an evaluation function associated with the model formula; and an optimum operation variable computing step of performing, with the control unit, an inverse wavelet transform for the value of an optimum wavelet coefficient computed in the optimum wavelet coefficient value computing step and computing, with the control unit, an optimum operation variable.

A variable deciding device according to the present invention is a variable deciding device for deciding an operation variable to be inputted into a model formula which expresses a batch process to be operated according to an operation variable, characterized by comprising: acceptance means for accepting an operation variable after batch process operation from an input unit; computation means for computing a wavelet coefficient for the operation variable accepted by the acceptance means; selection means for selecting a wavelet coefficient which satisfies a predetermined condition from wavelet coefficients computed by the computation means; and output means for outputting the wavelet coefficient selected by the selection means as a value associated with an operation variable to be inputted into a model formula which expresses a batch process.

A variable deciding device according to the present invention is characterized in that the selection means is constructed to select a wavelet coefficient, which is computed by the computation means, of a level which is higher than or equal to a predetermined threshold.

A variable deciding device according to the present invention is characterized in that the selection means is constructed to select a wavelet coefficient, which is computed by the computation means, having an absolute value which is larger than or equal to a predetermined value.

A variable deciding device according to the present invention is characterized in that the selection means is constructed to select a wavelet coefficient relating to a low-frequency component of a wavelet coefficient, which is computed by the computation means, of a level which is higher than or equal to a predetermined threshold.

A variable deciding device according to the present invention is characterized in that the selection means is constructed to select all or a part of wavelet coefficients relating to a low-frequency component and a part of wavelet coefficients relating to a high-frequency component of a wavelet coefficient, which is computed by the computation means, of a level which is higher than or equal to a predetermined threshold.

A variable deciding device according to the present invention is characterized in that the selection means is constructed to select a wavelet coefficient having an absolute value which is larger than or equal to a predetermined value from wavelet coefficients, which are computed by the computation means, of a level which is higher than or equal to a predetermined threshold.

A variable deciding device according to the present invention is characterized by further comprising: optimum wavelet coefficient value computing means for inputting the selected wavelet coefficient outputted by the output means into a model formula and computing a value of a wavelet coefficient which gives an optimum evaluated value of an evaluation function associated with the model formula; and optimum operation variable computing means for performing an inverse wavelet transform for the value of an optimum wavelet coefficient computed by the optimum wavelet coefficient value computing means and computing an optimum operation variable.

A program according to the present invention is a program for causing a computer to decide an operation variable to be inputted into a model formula which expresses a batch process to be operated according to an operation variable, characterized by causing a computer to execute: an acceptance step of accepting an operation variable after batch process operation from an input unit; a computation step of computing, with the control unit, a wavelet coefficient for the operation variable accepted in the acceptance step; a selection step of selecting, with the control unit, a wavelet coefficient which satisfies a predetermined condition from wavelet coefficients computed in the computation step; and an output step of outputting, with the control unit, the wavelet coefficient selected in the selection step as a value associated with an operation variable to be inputted into a model formula which expresses a batch process.

A program according to the present invention is characterized by further causing execution of: an optimum wavelet coefficient value computing step of inputting, with the control unit, the selected wavelet coefficient outputted in the output step into a model formula and computing, with the control unit, a value of a wavelet coefficient which gives an optimum evaluated value of an evaluation function associated with the model formula; and an optimum operation variable computing step of performing, with the control unit, an inverse wavelet transform for the value of an optimum wavelet coefficient computed in the optimum wavelet coefficient value computing step and computing, with the control unit, an optimum operation variable.

A recording medium according to the present invention is a computer-readable recording medium which stores a program for causing a computer to decide an operation variable to be inputted into a model formula which expresses a batch process to be operated according to an operation variable, characterized by causing a computer to execute: an acceptance step of accepting an operation variable after batch process operation from an input unit; a computation step of computing, with the control unit, a wavelet coefficient for the operation variable accepted in the acceptance step; a selection step of selecting, with the control unit, a wavelet coefficient which satisfies a predetermined condition from wavelet coefficients computed in the computation step; and an output step of outputting, with the control unit, the wavelet coefficient selected in the selection step as a value associated with an operation variable to be inputted into a model formula which expresses a batch process.

A recording medium according to the present invention is characterized by further causing execution of: an optimum wavelet coefficient value computing step of inputting, with the control unit, the selected wavelet coefficient outputted in the output step into a model formula and computing, with the control unit, a value of a wavelet coefficient which gives an optimum evaluated value of an evaluation function associated with the model formula; and an optimum operation variable computing step of performing, with the control unit, an inverse wavelet transform for the value of an optimum wavelet coefficient computed in the optimum wavelet coefficient value computing step and computing, with the control unit, an optimum operation variable.

In the present invention, a variable deciding device accepts an input of an operation variable after batch process operation from an input unit. The variable deciding device then computes a wavelet coefficient by applying a wavelet transform to the accepted operation variable. Selection means selects a wavelet coefficient which satisfies a predetermined condition from computed wavelet coefficients. Here, a selection is made, for example, by: selecting a wavelet coefficient, which is computed by computation means, of a level which is higher than or equal to a predetermined threshold; selecting a wavelet coefficient, which is computed by the computation means, having an absolute value which is larger than or equal to a predetermined value; selecting a wavelet coefficient relating to a low-frequency component of a wavelet coefficient, which is computed by the computation means, of a level which is higher than or equal to a predetermined threshold; selecting all or a part of wavelet coefficients relating to a low-frequency component and a part of wavelet coefficients relating to a high-frequency component of a wavelet coefficient, which is computed by the computation means, of a level which is higher than or equal to a predetermined threshold; or selecting a wavelet coefficient having an absolute value which is larger than or equal to a predetermined value from wavelet coefficients, which are computed by the computation means, of a level which is higher than or equal to a predetermined threshold.

The wavelet coefficient selected in such a manner is then outputted by output means as a value associated with an operation variable to be inputted. Accordingly, the total number of values associated with an operation variable to be inputted into a model formula diminishes and prediction performance based on a model formula is improved.

In the present invention, the selected wavelet coefficient outputted by the output means is inputted into a model formula. A value of a wavelet coefficient which gives an optimum evaluated value of an evaluation function associated with the model formula is then computed. An inverse wavelet transform is performed for the computed value of an optimum wavelet coefficient and an optimum operation variable is computed. Accordingly, it becomes possible to provide an optimum operation variable based on a result having a high degree of estimate accuracy for a process.

### ADVANTAGEOUS EFFECTS OF INVENTION

In the present invention, a wavelet coefficient of an accepted operation variable is computed and a wavelet coefficient which satisfies a predetermined condition is selected from computed wavelet coefficients. The selected wavelet coefficient is then outputted by the output means as a value associated with an operation variable to be inputted. Accordingly, the total number of values associated with an operation variable to be inputted into a model formula diminishes and prediction performance based on a model formula is improved. Moreover, since time information is not lost depending on a wavelet analysis, it becomes possible to make effective use of a wavelet coefficient which is selected reflecting time information, causing enhancement of estimate accuracy of a model.

In the present invention, the selected wavelet coefficient outputted by the output means is inputted into a model formula and a value of an optimum wavelet coefficient is computed. An inverse wavelet transform is then performed for the computed value of an optimum wavelet coefficient and an optimum operation variable is computed. Moreover, the present invention guarantees beneficial effects such as provision of an optimum operation variable based on a result having a high degree of estimate accuracy for a process, by performing further dimension compression combined further with a multivariate analysis in addition to dimension compression by a wavelet analysis.

### BRIEF DESCRIPTION OF DRAWINGS

FIG. 1 A block diagram for showing the hardware structure of a variable deciding device according to the present invention

FIG. 2 A flow chart for showing the procedure of a selection process of a wavelet coefficient

FIG. 3 A flow chart for showing the procedure of a selection process example 1 of a wavelet coefficient

FIG. 4 A flow chart for showing the procedure of a selection process example 2 of a wavelet coefficient

FIG. 5 A flow chart for showing the procedure of a selection process example 3 of a wavelet coefficient

FIG. 6 A flow chart for showing the procedure of a selection process example 4 of a wavelet coefficient

FIG. 7 A flow chart for showing the process procedure for computing an optimum operation variable

FIG. 8 A flow chart for showing the process procedure for computing an optimum operation variable

FIG. 9 A graph for showing a change in an input signal with respect to time

FIG. 10 Graphs for showing a change in a wavelet coefficient

FIG. 11 Graphs for showing a result of model construction by conventional MPCR

FIG. 12 Graphs for showing a result of model construction in a case where a process according to the present invention is performed

FIG. 13 Graphs for showing a result of model construction by MPCR

FIG. 14 Graphs for showing a result of model construction after a selection process according to the present invention

FIG. 15 A graph for showing a temporal change in an operation variable for each desired production

FIG. 16 A graph for showing a result of optimization

FIG. 17 A block diagram for showing the structure of a computer according to Embodiment 2

FIG. 18 Graphs for showing a result of verification

FIG. 19 A graph for showing a temporal change in a substrate inlet rate

FIG. 20 A graph for showing a result of optimization

### REFERENCE SIGNS LIST

1 Computer (Variable Deciding Device)
1A Portable Recording Medium
11 CPU (Control Unit)
12 RAM
13 Input Unit
14 Display Unit
15 Storage Unit
15P Control Program

### DESCRIPTION OF EMBODIMENTS

### Embodiment 1

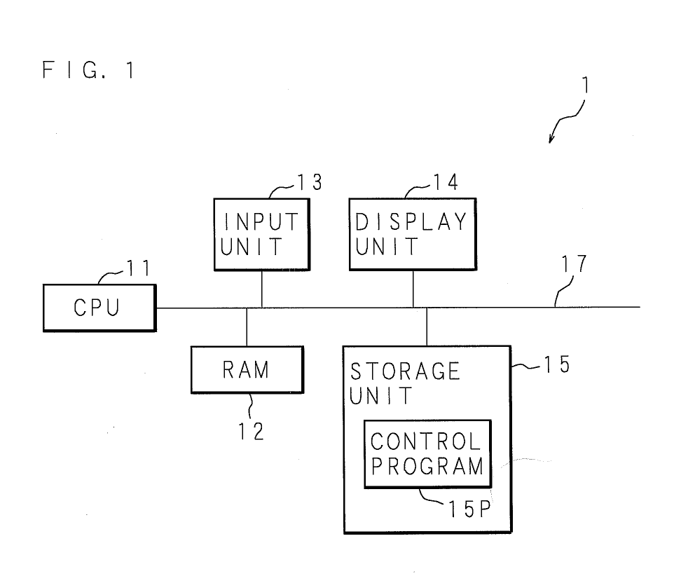

The following description will explain an embodiment of the present invention with reference to the drawings. FIG. 1 is a block diagram for showing the hardware structure of a variable deciding device according to the present invention. Denoted at 1 in the figure is a variable deciding device which is constituted of a computer, for example. The variable deciding device 1 will be explained hereinafter as a computer 1. The computer 1 comprises a CPU 11 which functions as a control unit, a RAM (Random Access Memory) 12, a storage unit 15, a display unit 14 and an input unit 13 which are connected via a bus 17. The CPU 11, which is connected with respective hardware units via the bus 17, controls the respective hardware units and executes various software functions according to a control program 15P which is stored in the storage unit 15. The control program 15P is described in a programming language such as C. The RAM 12 temporarily stores data which is to be used for computation by the CPU 11.

The storage unit 15 is constituted of a hard disk, for example, and stores therein the control program 15P described above. The display unit 14 is a liquid crystal display, for example. The input unit 13 is composed of a keyboard and a mouse, a reading unit of a recording medium such as a CD-ROM, a LAN card, or the like. The input unit 13 accepts an input of operation history in a batch process, i.e., respective data such as an operation variable uᵢ (variable having an operational profile) which changes temporally, an operation variable S (variable not having an operational profile) which does not change temporally, and a quality variable Y.

When operation is terminated in a batch process, respective data to be operation history, i.e., a quality variable Y, an operation variable uᵢ and an operation variable S are respectively inputted. Said quality variable Y represents the cost, the quantity, the quality or the like of a product to be manufactured in a batch process, for example, and it is assumed that a condition of yεR^{Q} is satisfied in the following description. Moreover, the operation variable uᵢ (i=1, 2, . . . , I) represents a series obtained by sampling operation variables of respective variables from operation variables of a batch process, assuming that the number of variables which change temporally is I. The operation variable uᵢ is, for example, a variable of temperature (x_{1,1}, x_{1,2}, . . . , x_{1,t}, x_{1,T}: time (sampling point) t=1, 2, . . . , T) which changes temporally in a batch process, or a rate of flow (x_{2,1}, x_{2,2}, . . . , x_{2,t}, x_{2,T}) which changes temporally.

On the other hand, an operation variable S is a variable which does not change temporally and, for example, a pressure value which does not change temporally or a value indicating whether a specific device is used or not corresponds thereto. It should be noted that a condition of SεR^{L} is satisfied in the following description. The CPU 11 accepts a quality variable Y, an operation variable uᵢ and an operation variable S inputted from the input unit 13 and stores the same in the storage unit 15. The CPU 11 then reads out an operation variable uᵢ stored in the storage unit 15 and selects an operation variable uᵢ according to a predetermined condition by a process which will be described later.

The CPU 11 reads out an operation variable uᵢ stored in the storage unit 15 and executes a wavelet analysis of a level J. The wavelet analysis will be explained hereinafter. The wavelet analysis is a method which can take a signal from both time and frequency aspects and is referred to as a time-frequency analysis. Now, think about a functional space {ψ((x−b)/a)}_{a,b}, on the assumption that a, bεR is satisfied. Here, a represents a scale transform of a function ψ and b represents translation (translate). The element of such a functional space is referred to as a wavelet. A wavelet transform W_{f}(b, a) of a signal f is defined by Math. 1.

$$\begin{matrix}[ Math . 1 ] & \\ {W}_{f} ( b , a ) = {\int }_{- ∞}^{∞} \frac{1}{\sqrt{\vert α \vert}} ψ ( \frac{x - b}{a} ) f ( x ) d x & ( 1 )\end{matrix}$$

It is possible to obtain the strength of a signal at a time and a frequency (correlation between a wavelet and a signal) by changing a and b. In the present embodiment, a binary wavelet transform having a discrete wavelet is used. This is a wavelet transform for discretizing a combination (b, a) of a scale and a translate to (2^{j}k, 2^{j})(j, kεZ). Here, a discretization parameter j is hereinafter referred to as a level, which corresponds to a frequency. A scaling function φ and a wavelet ψ which are basis functions in a discrete wavelet transform satisfy a 2-scale relation expressed in the following Math. 2 and Math. 3.

$$\begin{matrix}[ Math . 2 ] & \\ φ ( x ) = {\sum }_{k ∈ z} {p}_{k} φ ( 2 x - k ) & ( 2 ) \\ [ Math . 3 ] & \\ ψ ( x ) = {\sum }_{k ∈ z} {q}_{k} φ ( 2 x - k ) & ( 3 )\end{matrix}$$

Here, {pⱼ} and {qₖ} are referred to as 2-scale sequences, which are sequences for deciding a scaling function and a wavelet. When a scaling function φ is given, a space Vⱼ spanned by {φ(2^{-j}x−k)} is decided for each level j. Accordingly, an arbitrary function fⱼεVⱼ can be expressed in Math. 4 using a coefficient {ak(j)}.

$$\begin{matrix}[ Math . 4 ] & \\ {f}_{j} ( x ) = {\sum }_{k} {a}_{k}^{( j )} φ ( {2}^{- j} x - k ) & ( 4 )\end{matrix}$$

It should be noted that Vⱼ₊₁⊂Vⱼ is satisfied due to the 2-scale relation. When ψ corresponding to is given, a space Wⱼ spanned by {ψ(2^{-j}x−k)} is decided. Accordingly, an arbitrary function g_{J}εWⱼ is expressed as Math. 5 using a coefficient {dₖ^{(j)}}.

$$\begin{matrix}[ Math . 5 ] & \\ {g}_{j} ( x ) = {\sum }_{k} {d}_{k}^{( j )} φ ( {2}^{- j} x - k ) & ( 5 )\end{matrix}$$

Furthermore, fⱼ is decomposed uniquely as expressed in Math. 7, since a condition expressed in Math. 6 is satisfied.

[Math. 6]

Vⱼ=Vⱼ₊₁⊕Wⱼ₊₁ (6)

[Math. 7]

fⱼ=fⱼ₊₁+gⱼ₊₁ (7)

Here, fⱼ₊₁ is a low-frequency component of fⱼ and gⱼ₊₁ is a high-frequency component, which are respectively referred to as Approximation and Detail. Moreover, aⱼ={ak(j)} and dⱼ={dₖ^{(j)}} are respectively referred to as an Approximation coefficient (A coefficient in the following description) and a Detail coefficient (D coefficient in the following description) of a level j and are to collectively referred to as a wavelet coefficient. Decomposition by a wavelet equals to decision of wavelet coefficients aⱼ and dⱼ. A wavelet coefficient is obtained from an inner product of a wavelet and a signal. For example, an A coefficient aⱼ of a level j is obtained from Math. 8, on the basis of an inner product of a scaling function φ and a signal fⱼ.

$$\begin{matrix}[ Math . 8 ] & \\ {a}_{k}^{( j )} = {2}^{- j} {\sum }_{x = - ∞}^{∞} φ ( {2}^{- j} x - k ) {f}_{j} ( x ) & ( 8 )\end{matrix}$$

It should be noted that a scaling coefficient is normalized by Math. 9.

$$\begin{matrix}[ Math . 9 ] & \\ {\sum }_{x = - ∞}^{∞} φ ( x ) = 1 & ( 9 )\end{matrix}$$

It should be noted that this decomposition halves the resolution of a signal, that is, a sampling frequency of an obtained signal becomes ½ of a sampling frequency of an original signal. The wavelet analysis described above is used not only for feature extraction of a signal but for compression and reconstruction of a signal. It is known that almost all signals can be reconstructed almost completely with only a point having a large absolute value of a wavelet coefficient, when a signal is reconstructed using a suitable wavelet. In the present invention, the nature of a wavelet that the rough shape of an original signal can be reconstructed even when a number of coefficients having a small absolute value are thinned out is used for performing a process of selecting a wavelet coefficient having an absolute value which is larger than or equal to a threshold or a wavelet coefficient of a level which is higher than or equal to a specific level.

The CPU 11 decomposes a level Jᵢ by applying a wavelet transform to an operation variable uᵢ, so as to obtain wavelet coefficients a_{J,i} and d_{j,i}(i=1, 2, . . . , I; j=1, 2, . . . , Jᵢ). These can be expressed collectively as Math. 10.

[Math. 10]

cᵢ=[a_{J}_{ᵢ}_{,i}^{T}d_{1,i}^{T} . . . d_{J}_{ᵢ}_{,i}^{T}]^{T} (10)

A wavelet to be used here and a level Jᵢ of decomposition are decided according to a criterion which will be described later. Here, I wavelet coefficients cᵢ are aligned and expressed as Math. 11. It should be noted that a wavelet to be used may be a wavelet of an arbitrary method such as a Harr wavelet or a Daubechies wavelet.

[Math. 11]

c=[c₁^{T}c₂^{T} . . . c₁^{T}]^{T} (11)

Furthermore, matrices obtained by arranging s, c and y as rows for N batches are respectively represented by SεR^{N×L}, CεR^{N×P} and YεR^{N×Q}. The CPU 11 selects a wavelet coefficient which satisfies a predetermined condition from a matrix C, that is, thins out a column, which has been determined to be of slight importance, such as a column of wavelet coefficients having an absolute value which is smaller than or equal to a threshold or a column of wavelet coefficients of a specific level and obtains anew CεR^{N×M}.

In this selection process, for example, selected is: a wavelet coefficient of a level which is higher than or equal to a predetermined threshold such as a wavelet coefficient of a level 5; or a wavelet coefficient of a specific level, an absolute value of the value of which is larger than or equal to a predetermined value. Although the description of the present embodiment explains a case where a level to be a threshold is 5, a level higher than or equal to 5, such as 6, may be selected as required. Moreover, the CPU 11 may be constructed to select a wavelet coefficient (A coefficient) relating to a low-frequency component from wavelet coefficients of a level which is higher than or equal to a predetermined level and not to select a wavelet coefficient (D coefficient) relating to a high-frequency component. Furthermore, the CPU 11 may be constructed to select an A coefficient from wavelet coefficients of a level which is higher than or equal to a predetermined level and select a part of D coefficients such as a coefficient, an absolute value of the value of which is larger than or equal to a predetermined value, or a coefficient in a time zone when an hourly variation is large. The CPU 11 performs a process of setting a value of 0 to coefficients other than a coefficient selected in such a manner,

A matrix C processed by a selection process in such a manner is represented anew by CεR^{N×M}. Finally, the CPU 11 standardizes the respective columns of S, C and Y to a mean of 0 and a variance of 1 and then constructs a linear model having an input of S and C and an output of Y. The constructed linear model is expressed as Math. 12.

$$\begin{matrix}[ Math . 12 ] & \\ y = {K}^{T} [ \begin{matrix}s \\ c\end{matrix} ] + e & ( 12 )\end{matrix}$$

Here, KεR^{(L+M)×Q} is a regression coefficient matrix and eεR^{Q} is a residual. It should be noted that, although the description of the present embodiment explains an example wherein principal component regression (PCR) or partial least squares (PLS) is used as a model to be constructed, the present invention is not limited to this. For example, a linear regression method such as a multiple regression analysis or an arbitrary non-linear model construction method may be employed. It should be noted that a method of constructing a quality model for an input of operating data of a process and an output of quality data and deciding an operating condition which can realize desired quality on the basis of said model is described in detail in Non Patent Literatures 2 and 3.

A quality model of a batch process which uses PCR can be expressed in Math. 13.

$$\begin{matrix}[ Math . 13 ] & \\ \begin{matrix}y = {K}^{T} t \\ = {K}^{T} {V}_{R}^{T} z\end{matrix} & ( 13 )\end{matrix}$$

Here, yεR^{Q} is a quality variable, sεR^{L} is an operation variable which does not change temporally in a batch process, cεR^{M} is a wavelet coefficient based on an operation variable which changes temporally and z is expressed in Math. 14.

[Math. 14]

z=[s^{T}c^{T}]^{T}ε [symbol] ^{(L+M)} (14)

It is assumed that the respective variables y and z are standardized to a mean of 0 and a variance of 1. It is also assumed that KεR^{R×Q} is a regression coefficient matrix of PCR, tεR^{R} is a principal component score vector, V^{R}εR^{(L}^{⁺}^{M)×R} is a loading matrix and R is the number of principal components which are employed. Here, it is assumed that desired quality expressed in Math. 15 is given.

[Math. 15]

\tilde{y}ε [symbol] ^{Q} (15)

When R>Q is satisfied, a desired principal component score t(tilde) which gives y(tilde) is given by Math. 16.

[Math. 16]

\tilde{t}=(K^{T})⁺\tilde{y}+null(K^{T}) (16)

It should be noted that A⁺ represents a pseudo inverse matrix of a matrix A, null(A) represents a null space (kernel) of A, and dim(null(K^{T}))=R−Q is satisfied. Although an infinite number of solutions t(tilde) exist, it is assumed that a solution is decided uniquely here by optimization or the like and said solution is returned to a space of z.

[Math. 17]

\tilde{z}=V_{R}\tilde{t} (17)

Scaling is performed for z(tilde) obtained from Math. 17 using standard deviation of data for model construction and a mean is added thereto, so that Math. 18 is given anew.

[Math. 18]

\tilde{z}=[\tilde{s}^{T}\tilde{c}^{T}]^{T} (18)

Here, regarding c(tilde), 0 is inserted into a part of a coefficient which is thinned out at the time of model construction and a wavelet coefficient cᵢ(tilde) corresponding to the i^{th} operation variable is taken out. In a wavelet analysis, it is possible to obtain a desired operation variable uᵢ(tilde) by applying a wavelet inverse transform to cᵢ(tilde), since the rough shape of an original signal can be reconstructed only by a coefficient having a large absolute value. It is only necessary to convert s(tilde) and uᵢ(tilde) (i=1, 2, . . . , I) into operation variables to be inputted into a batch process finally.

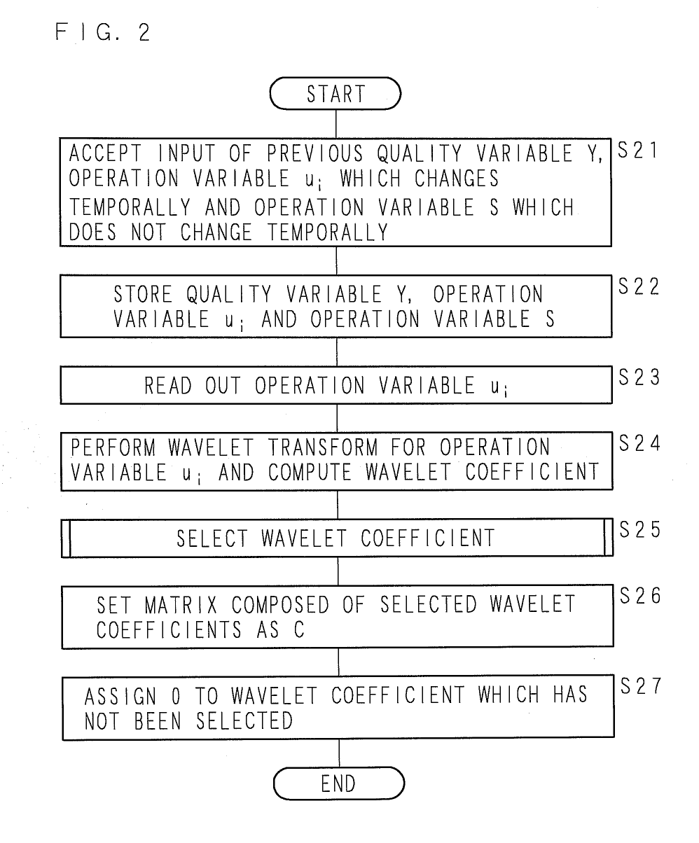

FIG. 2 is a flow chart for showing the procedure of a selection process of a wavelet coefficient. First, the CPU 11 accepts respective data of a previous quality variable Y to be inputted from the input unit 13, an operation variable uᵢ which changes temporally and an operation variable S which does not change temporally (step S21). Here, data which is stored in a recording medium may be accepted from the input unit 13 which functions as a recording medium reading device, or data which is outputted from another computer connected via a communication network that is not illustrated or from a control device for executing a process may be accepted. The CPU 11 stores the inputted quality variable Y, operation variable uᵢ and operation variable S in the storage unit 15 (step S22).

The CPU 11 reads out an operation variable uᵢ stored in the storage unit 15 (step S23). For performing a wavelet transform, the CPU 11 reads out a wavelet transform expression described above from the storage unit 15, assigns the read operation variable uᵢ to said transform expression and computes a wavelet coefficient (step S24). It should be noted that computation of a wavelet coefficient in the step S24 is executed for levels 1 to J and said level J may be set arbitrarily by an operator through the input unit 13 on the basis of an object, a condition and the like of a target process. The CPU 11 selects a wavelet coefficient which satisfies a predetermined condition from wavelet coefficients which are computed in such a manner (step S25). It should be noted that said process will be described later in detail.

The CPU 11 sets a matrix composed of selected wavelet coefficients as C (step S26) and stores said matrix in the storage unit 15. It should be noted that the CPU 11 may perform a heretofore known standardization process for said matrix C, operation variable S and quality variable Y with a mean of 0 and a variance of 1 and store the matrix C, the operation variable S and the quality variable Y after the standardization process. The CPU 11 also assigns 0 to wavelet coefficients which have not been selected (step S27). It should be noted that 0 is assigned to wavelet coefficients which have not been selected in the present embodiment. However, the present invention is not limited to this and it is only necessary to distinguish between a wavelet coefficient which has been selected and a wavelet coefficient which has not been selected by an arbitrary method such as setting of a flag to said wavelet coefficients.

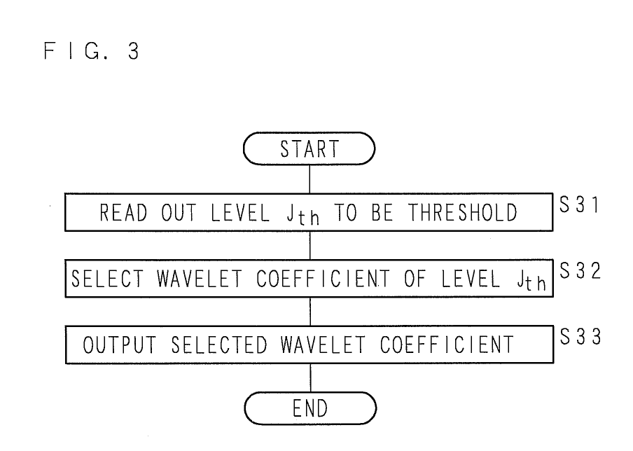

FIG. 3 is a flow chart for showing the procedure of a selection process example 1 of a wavelet coefficient. The CPU 11 reads out a level Jₜₕ, which is to be a threshold, from the storage unit 15 (step S31). Said level Jₜₕ, which is to be a threshold, is set to an arbitrary value on the basis of an object, a condition and the like of a process. The value of the level Jₜₕ is preliminarily imputed by an operator through the input unit 13 and stored in the storage unit 15. The CPU 11 selects a wavelet coefficient of a level Jₜₕ from wavelet coefficients computed in the step S24 for levels 1 to J (step S32). This may be an A coefficient and a D coefficient of a wavelet coefficient of a level Jₜₕ, for example. The CPU 11 outputs the selected wavelet coefficient to the storage unit 15, the display unit 14 or a peripheral equipment such as a printer which is not illustrated, as a value associated with an operation variable (step S33).

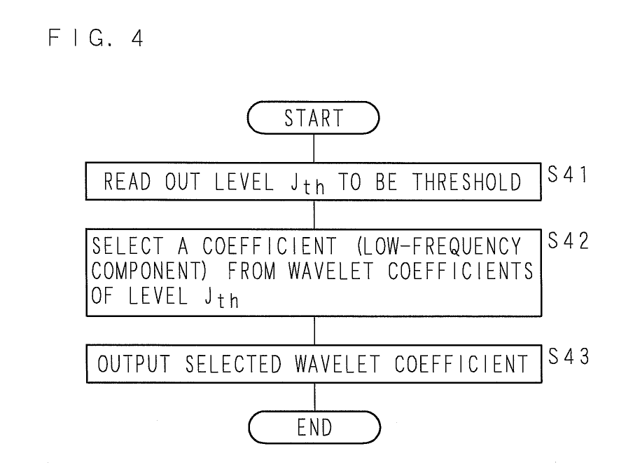

FIG. 4 is a flow chart for showing the procedure of a selection process example 2 of a wavelet coefficient. The CPU 11 reads out a level Jₜₕ, which is to be a threshold, from the storage unit 15 (step S41). The CPU 11 further selects an A coefficient relating to a low-frequency component from wavelet coefficients of a level Jₜₕ among wavelet coefficients computed in the step S24 for levels 1 to J (step S42). The CPU 11 outputs the selected wavelet coefficient to the storage unit 15 or the display unit 14 as a value associated with an operation variable (step S43).

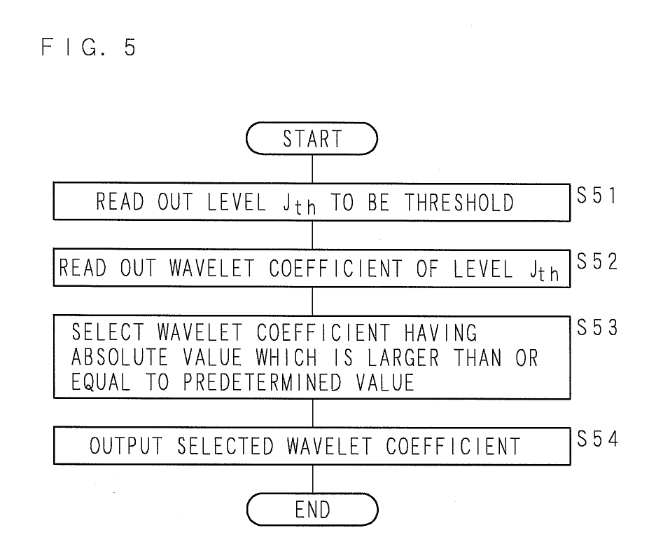

FIG. 5 is a flow chart for showing the procedure of a selection process example 3 of a wavelet coefficient. The CPU 11 reads out a level Jₜₕ, which is to be a threshold, from the storage unit 15 (step S51). The CPU 11 reads out a wavelet coefficient of a level Jₜₕ from wavelet coefficients computed in the step S24 for levels 1 to J (step S52). The CPU 11 then selects a wavelet coefficient, an absolute value of which is larger than or equal to a predetermined value (step S53). Regarding selection in such a process, for example, it is necessary to compute a mean value of absolute values of all coefficients and select a wavelet coefficient which is larger than or equal to the computed mean value. In addition, for selection, a predetermined value which is prestored in the storage unit 15 for each level may be read out by the CPU 11 and a wavelet coefficient which is larger than or equal to a predetermined value corresponding to the read level may be selected. Finally, the CPU 11 outputs the selected wavelet coefficient to the storage unit 15, the display unit 14 or the like as a value associated with an operation variable (step S54). It should be noted that performed in the selection process example 3 is a process to select a wavelet coefficient, an absolute value of which is larger than or equal to a predetermined value, from wavelet coefficients of a level Jₜₕ, a level of which is larger than or equal to a predetermined threshold. However, another process may be performed to convert said level Jₜₕ into a level 1 and select a wavelet coefficient of a level 1, an absolute value of which is larger than or equal to a predetermined value.

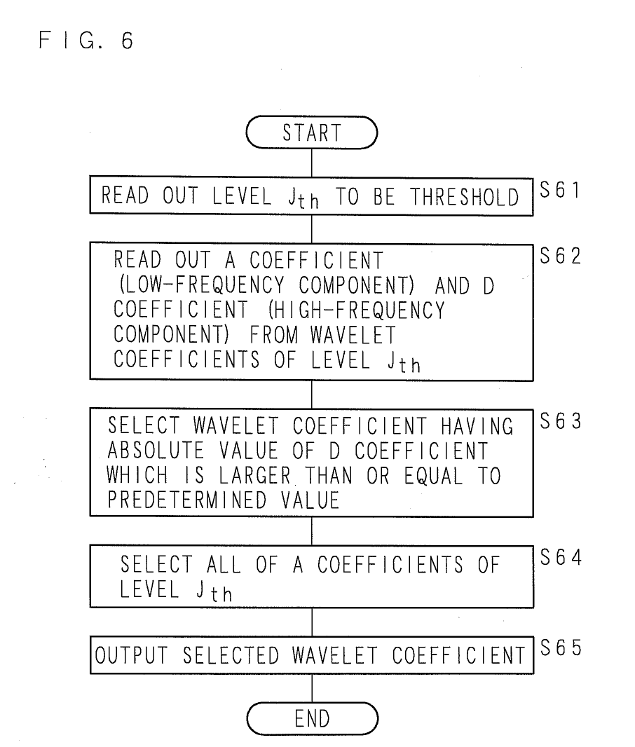

FIG. 6 is a flow chart for showing the procedure of a selection process example 4 of a wavelet coefficient. The CPU 11 reads out a level Jₜₕ, which is to be a threshold, from the storage unit 15 (step S61). The CPU 11 reads out wavelet coefficients (an A coefficient relating to a low-frequency component and a D coefficient relating to a high-frequency component) of a level Jₜₕ from wavelet coefficients computed in the step S24 for levels 1 to J (step S62). The CPU 11 selects a wavelet coefficient of a D coefficient, an absolute value of which is larger than or equal to a predetermined value (step S63).

Next, the CPU 11 selects all of A coefficients of a level Jₜₕ (step S64). That is, selected in the present selection process are Approximation coefficients of a wavelet coefficient of a predetermined level and a coefficient of a Detail coefficient of a wavelet coefficient of the same level, an absolute value of the value of which is larger than or equal to a predetermined value. It should be noted that a threshold for said absolute value can also be set to an arbitrary value by an operator through the input unit 13 on the basis of an object, a condition and the like of a process, and said value is stored in the storage unit 15. Finally, the CPU 11 outputs the selected wavelet coefficient to the storage unit 15, the display unit 14 or the like as a value associated with an operation variable (step S65). It should be noted that the CPU 11 performs a process to select all of A coefficients of a level Jₜₕ in the step S64. However, a part of A coefficients of a level Jₜₕ, i.e., a wavelet coefficient of an A coefficient, an absolute value of which is larger than or equal to a predetermined value, may be selected.

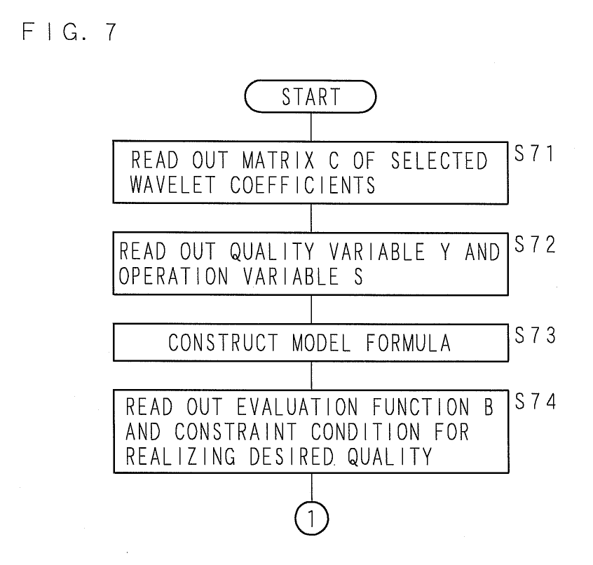

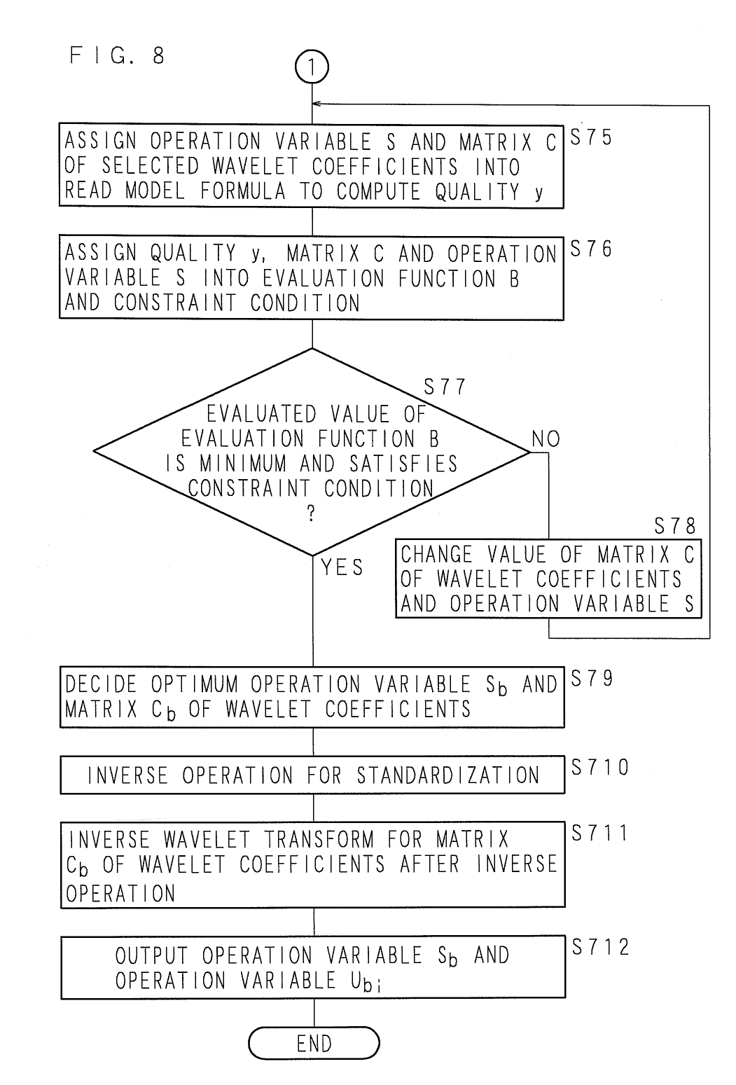

The following description will explain a process for constructing a model formula which expresses a batch process on the basis of a wavelet coefficient selected carefully in the above process and computing an optimum solution which satisfies desired quality. FIGS. 7 and 8 are a flow chart for showing the process procedure for computing an optimum operation variable. The CPU 11 reads out a matrix C of wavelet coefficients selected in the above process (step S71). The CPU 11 also reads out a quality variable Y and an operation variable S from the storage unit 15 (step S72). The CPU 11 executes wavelet coefficient regression and constructs a model formula from which a quality variable can be predicted on the basis of an operation variable (step S73). Said constructed model formula is stored in the storage unit 15. The model formula is generally expressed as Math. 19 for an input of matrices S and C and an output of Y.

[Math. 19]

y=f(s,c) (19)

It should be noted that construction of said model formula is achieved on the basis of a linear regression method such as principal component regression (PCR), partial least squares (PLS) or a multiple regression analysis or a heretofore known method such as an arbitrary non-linear model construction method, according to an object of a batch process, a quality condition and the like, and the model formula may be prestored in the storage unit 15.

The CPU 11 reads out an evaluation function B and a constraint condition for realizing desired quality stored in the storage unit 15 (step S74). Said evaluation function B is a function to be associated with the input variables s and c and the quality variable y of the model formula expressed in Math. 19, as shown in Math. 20. An evaluated value of said evaluation function B is, for example, the cost, the manufacturing speed or the like, and the values of s and c are decided so that said evaluated value becomes the minimum (or the maximum). It should be noted that the description of the present embodiment explains a process for deciding the values of operation variables s and c in a case where the evaluated value of the evaluation function B becomes the minimum. However, the operation variables s and c in a case where an evaluated value becomes the maximum may be obtained as long as operation variables s and c for an optimum evaluated value are obtained. For example, when an evaluated value based on the evaluation function B is the number of manufactured products, it is necessary to obtain operation variables s and c which give the maximum evaluated value.

$$\begin{matrix}[ Math . 20 ] & \\ {min}_{s , c} B ( y , s , c ) & ( 20 )\end{matrix}$$

Moreover, a constraint condition can be expressed in Math. 21. It should be noted that there is another constraint that, for example, the rate of flow is to be only a positive value when an operation variable S is a rate of flow, and an arbitrary constraint condition is added according to the type of a process.

[Math. 21]

\tilde{y}=f(s,c) (21)

It is also necessary for decision of the values of s and c to satisfy desired quality y(tilde) expressed in Math. 21. The CPU 11 assigns a matrix C of selected wavelet coefficients and an operation variable S into a model formula which has been read out from the storage unit 15 in the step S73 so as to compute quality y (step S75). The CPU 11 assigns the computed quality y, the matrix C and the operation variable S into the evaluation function B and a constraint condition which has been read out in the step S74 (step S76).

The CPU 11 determines whether an evaluated value of the evaluation function B is the minimum (or smaller than a predetermined reference value) and satisfies a constraint condition or not (step S77). When determining that the evaluation function B is not the minimum (or larger than or equal to a predetermined reference value) and does not satisfy a constraint condition (NO in step S77), the CPU 11 arbitrarily changes the value of the matrix C of wavelet coefficients and the operation variable S since this is not an optimum solution (step S78). In this case, an optimum solution can be obtained more efficiently since the size of matrix C has been significantly reduced by a selection process which uses a wavelet transform. After the process of the step S78, the CPU 11 proceeds again to the step S75 and repeats the above process. It should be noted that an optimum value may be obtained at once using a least squares method, although the value of the matrix C of wavelet coefficients and the operation variable S are arbitrarily changed in the present embodiment for optimization using quadratic programming (QP), non-linear programming (NLP) or the like.

When determining that the evaluated value of the evaluation function B is the minimum (or smaller than a predetermined reference value) and satisfies a constraint condition (YES in step S77), the CPU 11 decides the matrix C_{b} of wavelet coefficients and the operation variable S_{b} at the time as optimum values (step S79). The CPU 11 performs inverse operation to standardization with a mean of 0 and a variance of 1 for the matrix C_{b} of wavelet coefficients and the operation variable S_{b} (step S710). The CPU 11 then reads out a formula for executing an inverse wavelet transform from the storage unit 15 and performs an inverse wavelet transform for the matrix C_{b} after the inverse operation (step S711) so as to obtain an optimum operation variable u_{bi}.

Finally, the CPU 11 outputs the operation variable S_{b} and the operation variable u_{bi} to the storage unit 15, the display unit 14 or the like (step S712). An operator can apply an optimum operation variable, with which the computational complexity is reduced by a wavelet transform and estimate accuracy is further enhanced, to a batch process.

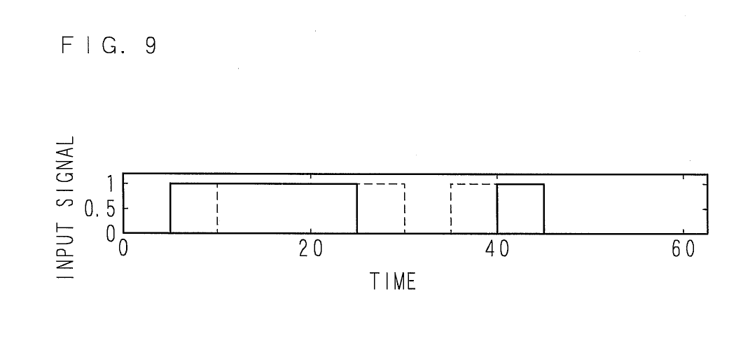

Next, a selection process according to the present invention will be explained using a concrete numerical value. Rectangular wave having a height of 1 and an input time and a width which change randomly according to uniform distribution was inputted twice into a linear system expressed in Math. 22 as an operation variable u, and an output y_{f} at an ending time T_{f}=63 was measured. FIG. 9 is a graph for showing a change in an input signal with respect to time. The abscissa axis represents time and the ordinate axis represents the magnitude of an input signal. Moreover, the continuous line represents a temporal change in the first input signal and the dotted line represents a temporal change in the second input signal. As shown in FIG. 9, it is understandable that the second signal was inputted after the first signal was inputted and, on the contrary, the first signal was inputted after the second signal was inputted after T_{f}=approximately 30.

[Math. 22]

\dot{x}=−0.01x+2u

y=0.1z (22)

Here, x is a state variable of a linear system and it is assumed that x(0)=0 is satisfied. A linear model for an input of a series u, which was obtained from sampling of u at a period of 1, and an output of y_{f} was constructed by a selection process which used a wavelet transform according to the present invention and Multiway PCR (MPCR). Regarding the wavelet transform, decomposition of a level of 5 was performed by a Daubechies wavelet (N=2) so as to obtain a wavelet coefficient. Here, N is a condition of a moment of a wavelet.

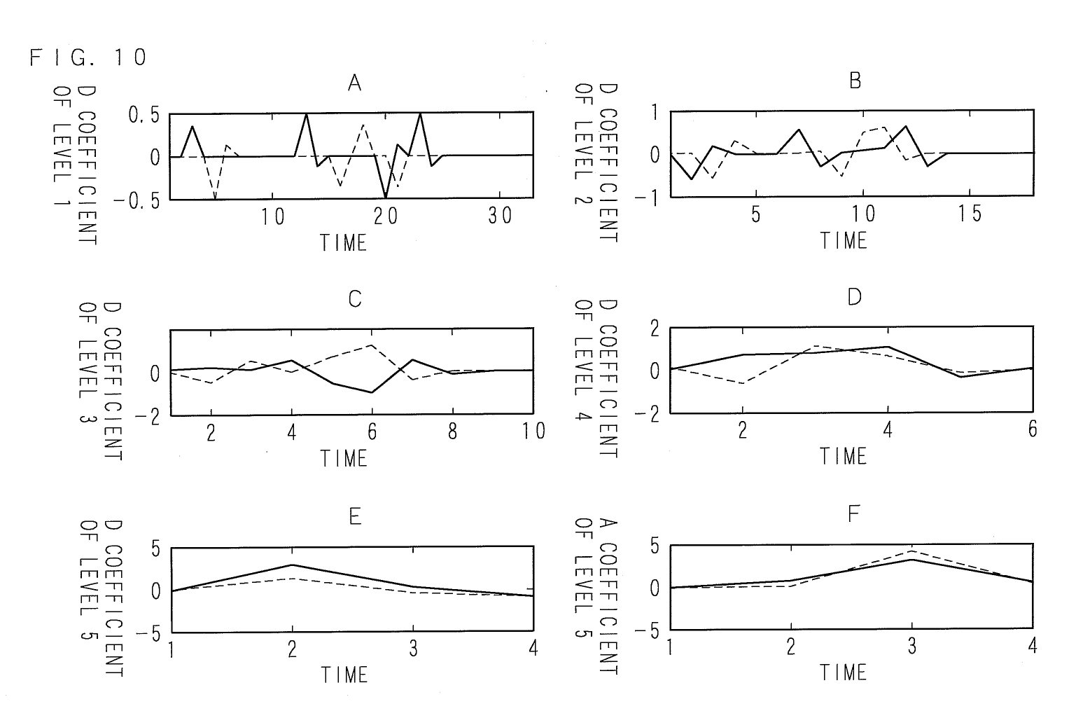

FIG. 10 is graphs for showing a change in a wavelet coefficient. In FIG. 10, the abscissa axis represents time and the ordinate axis represents a coefficient value of each level. Here, the continuous line represents a temporal change in a wavelet coefficient for the first signal and the dotted line represents a change in a wavelet coefficient for the second signal. Here, FIG. 10A is a graph for showing a temporal change in a D coefficient of a level 1, FIG. 10B is a graph for showing a temporal change in a D coefficient of a level 2, FIG. 10C is a graph for showing a temporal change in a D coefficient of a level 3, FIG. 10D is a graph for showing a temporal change in a D coefficient of a level 4, and FIG. 10E is a graph for showing a temporal change in a D coefficient of a level 5. Moreover, FIG. 10F is a graph for showing a change in an A coefficient of a level 5.

Here, although the input u was 64-dimension, mapping was achieved in 75-dimension by a wavelet transform. A model was constructed using PCR with only an input of A coefficients and a D coefficient of a level 5. As shown in FIG. 10, although the number of wavelet coefficients existing in a D coefficient of a level 1 was larger than or equal to 30, it is understandable that said number decreased to 4 at the stage of a level 5. The number of principal components employed was 8, which was the sum of A coefficients and D coefficients. That is, the dimension in the selection process was 8. It should be noted that data for model construction was 10-batch and verification of prediction performance was performed using another data of 10-batch for verification.

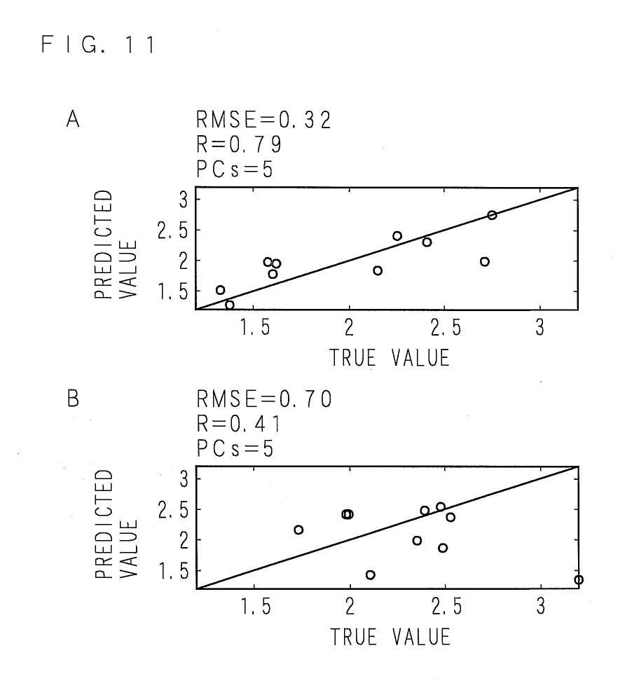

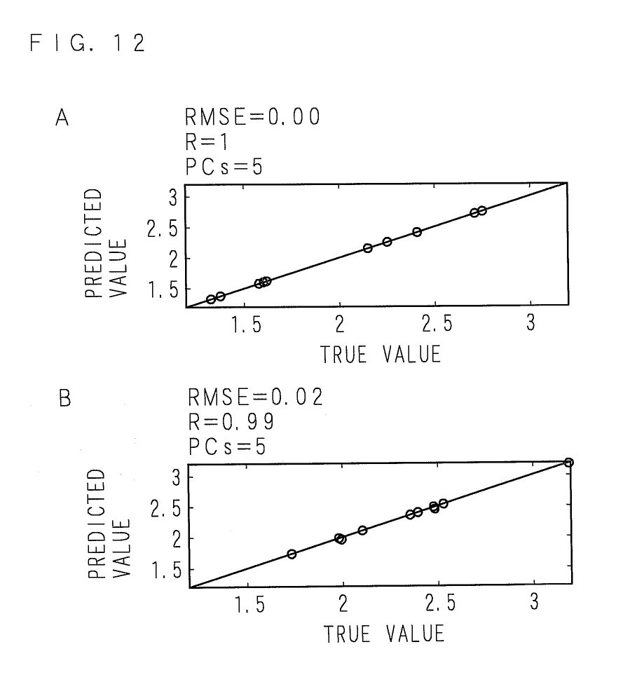

FIG. 11 is graphs for showing a result of model construction by conventional MPCR and FIG. 12 is graphs for showing a result of model construction in a case where a process according to the present invention is performed. In FIGS. 11 and 12, the abscissa axis represents a true value and the ordinate axis represents a predicted value. Moreover, FIGS. 11A and 12A show a prediction result of data for model construction and FIGS. 11B and 12B show a prediction result of data for verification. Here, RMSE represents a root-mean-square error, R represents a correlation coefficient of a true value and a predicted value, and PCₛ represents the number of principal components employed in PCR.

Here, the number of principal components was 5 in both, for comparison. When comparing FIG. 11 with FIG. 12, it is understood that, while prediction of data for verification could not be accomplished at all in MPCR, high prediction performance was realized for both of data for construction and data for verification when a selection process according to the present invention was used, and prediction performance was dramatically improved in comparison with MPCR. The reason why prediction performance was dramatically improved by a selection process as described above was that time information was utilized for model construction by a wavelet analysis. As shown in FIGS. 9, 10E and 10F, deviation of input time was represented, for example, in the magnitude of the second coefficient value and the third coefficient value of an A coefficient and the second coefficient value of a D coefficient of a level 5, and a wavelet coefficient could extract the feature associated with time of an operation variable successfully.

In the present numerical example, the magnitude of rectangular wave to be inputted was all 1, for simplicity. When a wavelet transform is performed on rectangular wave having different magnitude, it is impossible to distinguish deviation of input time and a difference in the magnitude of signals for one wavelet coefficient at the low-frequency side since the magnitude of a wavelet coefficient is proportional to the magnitude of an original signal. However, when a plurality of wavelet coefficients including the high-frequency side are used as an input, it becomes possible to construct a high-accuracy model even in such a case.

The effectiveness of a batch process quality improvement method which uses the selection process described above was verified by a case study method. A process to be object of the present case study was a lysine fermentation process of a semi-batch fermentation system. It should be noted that the details of said lysine fermentation process is disclosed in H. Ohno and E. Nakanishi: Optimal Operating Mode for a Class of Fermentation, Biotechnology & Bioengineering), 20, 625/636 (1978). Lysine is secondary metabolite produced while fungus grows and a substrate supply rate is given as an operation variable which changes temporally. An object of the present case study is to derive an optimum operation variable for obtaining a desired lysine production or the maximum lysine production. It should be noted that the details of a model which was used for simulation are as follows.

A model formula of a lysine production process to be used for the case study is expressed as Math. 23.

$$\begin{matrix}[ Math . 23 ] & \\ \frac{d X}{d t} = μ ( S ) X - \frac{Xu}{V} \\ \frac{d S}{d t} = - \frac{μ ( S ) X}{0.135} + \frac{( {S}_{0} - S ) u}{V} \\ \frac{d P}{d t} = Q ( μ ) X - \frac{Pu}{V} \\ \frac{d V}{d t} = u \\ μ ( S ) = 1.125 S \\ Q ( μ ) = - 384.0 {μ}^{2} + 134.0 μ & ( 23 )\end{matrix}$$

Here, X is a fungus concentration [ΔOD/100], S is a substrate concentration [kg/L], S₀ is a substrate rate of field [kg/L], P is a lysine concentration [g/L], u is a substrate supply rate [L/hr], and V is a tank liquid volume [L]. It is also assumed that a tank volume Vₘₐₓ=1000 kL is satisfied. Moreover, initial values in simulation were X(0)=0.035, S(0)=2.52, P(0)=0 and V(0)=60, and a substrate concentration of feed was S₀=2.52.

A process was operated using a variety of operation variables, and the lysine production y at a batch termination time T_{f}=40 h was measured. Assuming that the time series of sampling of an operation variable at a period of 20 min was u, a quality model for an input of u and an output of y was constructed using Multiway PCR (MPCR) and a method according to a selection process of the present invention. In a wavelet transform, decomposition of a level 5 was carried out using a Daubechies wavelet (N=8) and an obtained A coefficient was employed as a model input. Although an input u was 121-dimension and mapping was achieved in 194-dimension by a wavelet transform, the dimension of an input variable became 18 as a result of selection only of an A coefficient as an input variable.

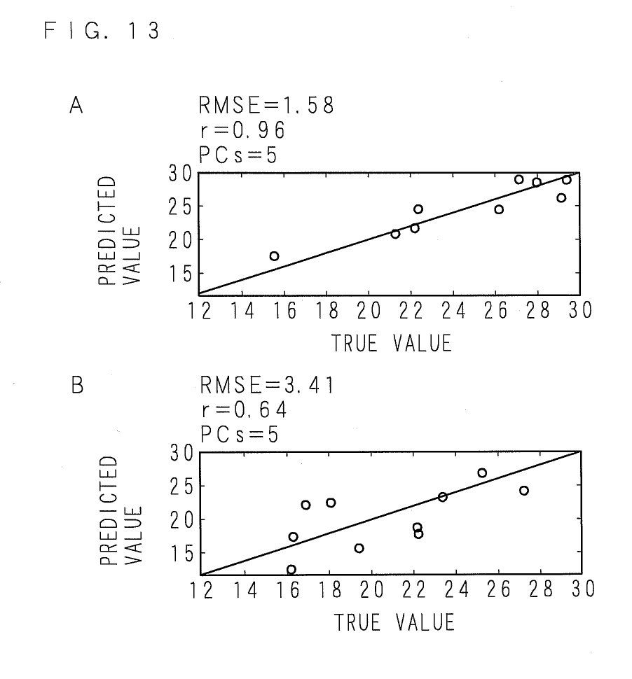

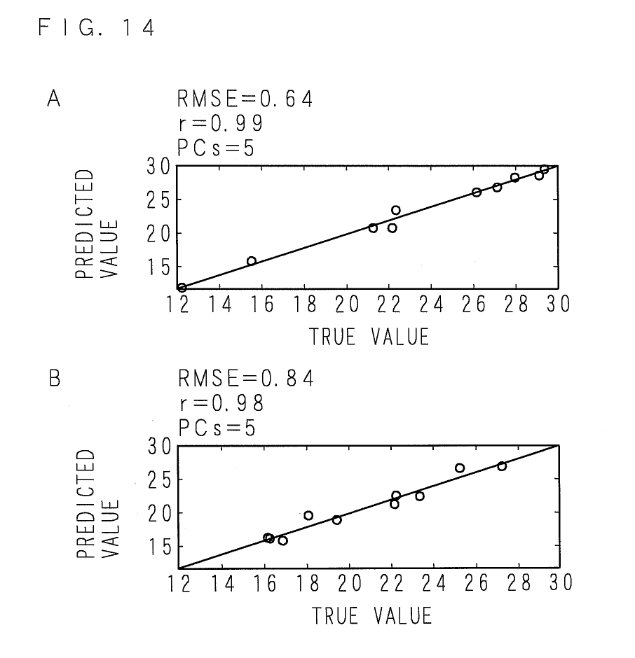

A model was then constructed for an input of an A coefficient using PCR. It should be noted that both of the number of samples for model construction and the number of samples for verification were 10-batch. FIG. 13 is graphs for showing a result of model construction by MPCR and FIG. 14 is graphs for showing a result of model construction after a selection process according to the present invention. For comparison, the number of principal components was 5 in each case. The results show that prediction performance for data for verification according to the present invention was improved in comparison with MPCR.

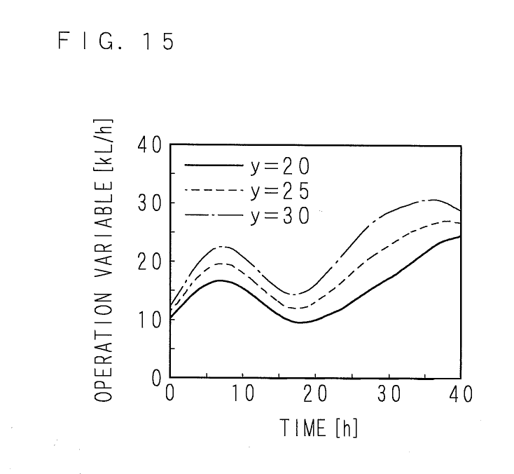

An operation variable which realizes desired production y(tilde)=20, 25, 30 was derived using a quality model constructed in a process of the present invention. Since the number of input variables of a quality model is larger than the number of quality variables, it is impossible to decide a solution uniquely. Consequently, an operation variable which is to be a least-norm solution for null(K^{T})=0 was derived here in Math. 16. FIG. 15 is a graph for showing a temporal change in an operation variable for each desired production. In FIG. 15, the abscissa axis represents time and the ordinate axis represents an operation variable. The realized production was respectively 21.8, 26.6 and 31.5, which was in excellent agreement with the desired value.

Next, optimization of an operation variable was carried out with the aim of minimization of a substrate supply in a case of y(tilde)=30 (case 1) and maximization of a lysine production at a batch termination time Tf (case 2). Introduced as constraint conditions were three conditions of: 1) the tank liquid volume does not exceed the tank volume Vₘₐₓ=1000 kL; 2) the substrate supply rate does not become negative; and 3) the solution is interpolation of data for model construction. Assurances are offered that the solution is interpolation of data for model construction as long as the statistic T² of data for model construction defined by Math. 24 does not exceed the control limit thereof.

$$\begin{matrix}[ Math . 24 ] & \\ {T}^{2} = {\sum }_{r = 1}^{R} \frac{{t}_{r}^{2}}{{σ}_{{t}_{r}}^{2}} & ( 24 )\end{matrix}$$

Here, tᵣ is the r^{th} principal component score, σ²ₜᵣ is dispersion of tᵣ, and xₚ and x(hat)ₚ are respectively a measured value and a predicted value (reconstructed value) of the p^{th} variable. R and P are respectively the number of principal components and the number of input variables employed. It should be noted that the present case study used not a constraint condition for the T² statistic of an A coefficient which is an input variable but a constraint that a principal component score does not exceed the upper and lower limit defined by the maximum value and the minimum value of a principal component score of data for model construction. In such a manner, optimization computation was facilitated and assurances were offered that the solution was interpolation of data for model construction.

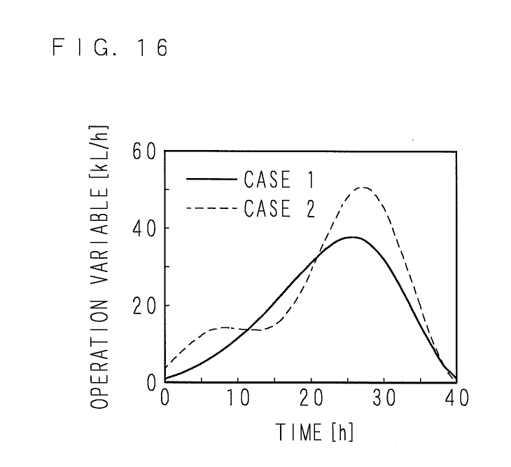

FIG. 16 is a graph for showing a result of optimization. The abscissa axis represents time and the ordinate axis represents an operation variable, and shown is a temporal change in an operation variable respectively in the case 1 and the case 2 described above. Said optimization caused a decrease of a substrate supply in the case 1 from 892 of the least-norm solution to 782. Moreover, a realized lysine production was 30.2, which was in excellent agreement with the desired value. In the case 2, an obtained lysine production was 35.7 and a tank liquid volume at the batch termination time was in agreement with the tank volume Vₘₐₓ.

### Embodiment 2

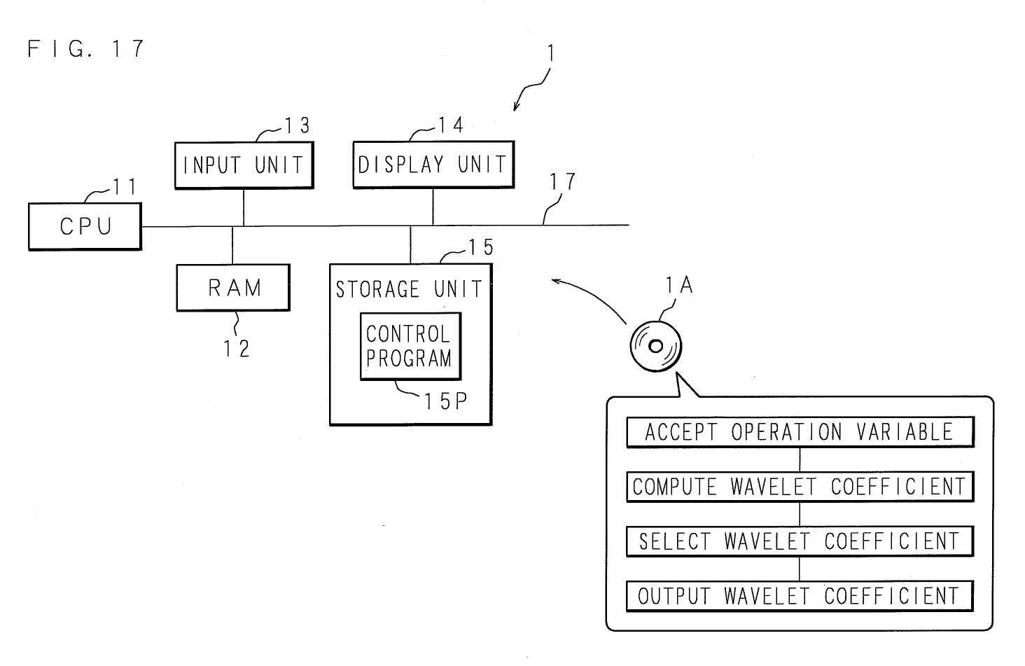

FIG. 17 is a block diagram for showing the structure of a computer 1 according to Embodiment 2. A computer program for causing a computer 1 according to Embodiment 1 to operate can also be provided by a portable recording medium 1A such as a CD-ROM or a memory card as in the present Embodiment 2. Furthermore, a computer program can also be downloaded from a server computer, which is not illustrated, via a communication network, which is not illustrated, such as a LAN or the Internet. The following description will explain the content thereof.

The portable recording medium 1A storing a computer program for causing the input unit 13, which functions as a recording medium reading device of the computer 1 shown in FIG. 17, to accept an operation variable, compute a wavelet coefficient, select a wavelet coefficient and output a wavelet coefficient is inserted so as to install said program into a control program 15P of the storage unit 15. Alternatively, such a program may be downloaded from an external server computer, which is not illustrated, via a communication unit, which is not illustrated, and installed to the storage unit 15. Such a program is loaded to the RAM 12 and executed. In such a manner, such a program functions as the computer 1 according to the present invention as described above.

Since the present Embodiment 2 has a structure described above and other structures and functions are the same as those of Embodiment 1, like codes are used to refer to like parts and detailed explanation thereof is omitted.

### Embodiment 3

Embodiment 3 relates to an embodiment for verifying the effectiveness using a production process of penicillin which is a semi-batch fermentation system. Penicillin is secondary metabolite produced while fungus grows and a substrate inlet rate is given as an operational profile. An object of the present case study is to derive an optimum operational profile which realizes a desired penicillin concentration. The details of a model which uses simulation are shown in the following description.

A model of a penicillin production process which uses case study is shown in the following Math. 25. It should be noted that the specific growth rate of fungus is represented in a Monad type and a volume change with inlet of substrate is ignored. Moreover, the fungus growth inhibitor concentration was ignored assuming that the same is sufficiently small.

$$\begin{matrix}[ Math . 25 ] & \\ \frac{d X}{d t} = μ ( S ) X \\ \frac{d S}{d t} = - a μ ( S ) X + u \\ \frac{d A}{d t} = [ {a}_{0} + {a}_{1} ( \frac{K}{X} ) + {{a}_{2} ( \frac{K}{X} )}^{2} ] \\ \frac{d K}{d t} = X \\ μ ( S ) = \frac{{k}_{1} S}{{k}_{s} + S} \\ & ( 25 )\end{matrix}$$

Here, X is a fungus concentration [g/L], S is a substrate concentration [g/L], A is a penicillin concentration [arbitary-units/L], and u is a substrate inlet rate [g/L-hr]. Moreover, K is a value [hr-g/L]defined by Math. 26.

[Math. 26]

K=∫₀^{t}X(t)dt (26)

The value of each parameter is k₁=0.066[1/hr], kₛ=1.0 [g/L], α=1.87 [−], a₀=3.8×10⁻³ [arbitary-units L/g-hr], a₁=1.9×10⁻³ [arbitary-units L/g-hr], and a₂=−1.41×10⁻⁵ [arbitary-units L/g-hr]. The initial values in simulation were X₀=1.0, S₀=10.0, A₀=0, and K₀=0.

A process was operated using a variety of operational profiles u, and a penicillin concentration y was measured at a batch termination time T_{f}=120 hr. Assuming that a series obtained from sampling of an operation file u with a period of 1 hr was {u}, a quality model for an input (201 variables) of {u} and an output of y was constructed using Multiway PCR (MPCR) and WCR. In WCR, decomposition of a level 5 was performed using a Daubechies wavelet (N=8) and PCR was used for an input of Approximation coefficients (18 coefficients). It should be noted that the number of samples for model construction was 10-batch and the number of samples for verification was 10-batch.

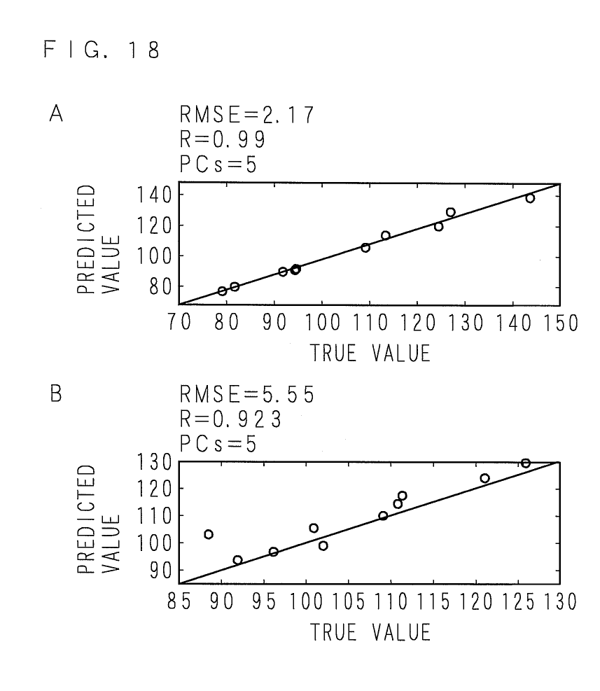

FIG. 18 is graphs for showing a result of verification. FIG. 18A shows a result of WCR and FIG. 18B shows a result of MPCR. It should be noted that the number of principal components was 5, for comparison. The results show that prediction performance for data for verification of WCR was improved in comparison with MPCR. An operational profile which realizes desired quality y(tilde)=100, 110, 120 was derived using a quality model constructed by WCR. Since the number of input variables of a quality model is larger than the number of quality variables, it is impossible to decide a solution uniquely. Consequently, an operational profile was derived using a least-norm solution here.

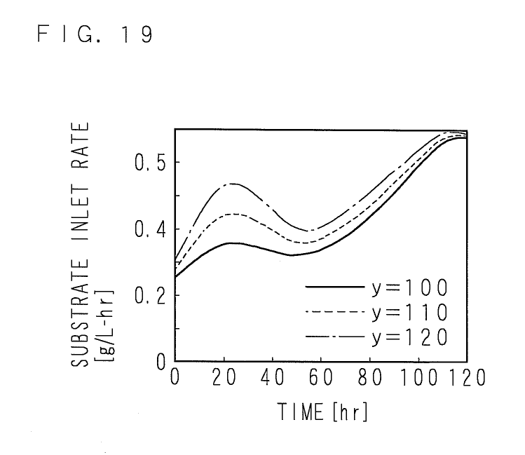

FIG. 19 is a graph for showing a temporal change in a substrate inlet rate. The abscissa axis represents time and the ordinate axis represents a substrate inlet rate. The continuous line in FIG. 19 represents desired quality y(tilde)=100, the dotted line represents desired quality y(tilde)=110, and the long dashed short dashed line represents desired quality y(tilde)=120. The realized quality was 102.0, 113.3 and 120.3, which was in excellent agreement with the desired quality.

Furthermore, when y(tilde)=100 was satisfied, an operational profile was optimized with the aim of minimization of operation cost. It was assumed that the cost required for an operation is proportional to an input of substrate and a substrate inlet rate does not become negative as a constraint condition.

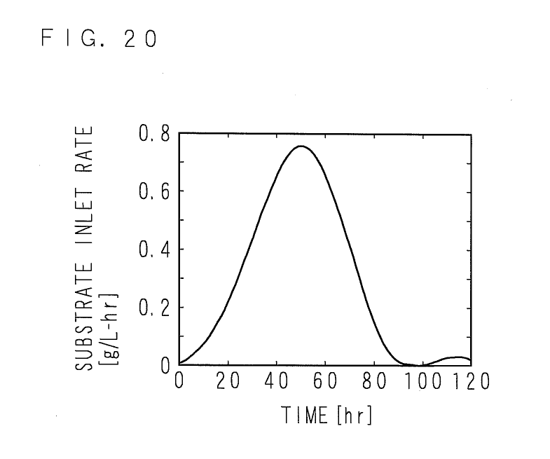

FIG. 20 is a graph for showing a result of optimization. Similar to FIG. 19, FIG. 20 shows a temporal change in a substrate inlet rate, and the abscissa axis represents time and the ordinate axis represents a substrate inlet rate. In such a manner, the operation cost decreased from an operation cost 51.1 of a least-norm solution to 33.9. Moreover, the realized quality was 98.8. From the above description, the effectiveness of WCR and a quality improvement method suggested was shown.

1-13. (canceled)

14. A variable deciding method for deciding an operation variable to be inputted into a model formula which expresses a batch process to be operated according to an operation variable, comprising:
an acceptance step of accepting an operation variable after batch process operation from an input unit;
a computation step of computing a wavelet coefficient for the operation variable accepted in the acceptance step;
a selection step of selecting a wavelet coefficient which satisfies a predetermined condition from wavelet coefficients computed in the computation step; and
an output step of outputting the wavelet coefficient selected in the selection step as a value associated with an operation variable to be inputted into a model formula which expresses a batch process.

15. The variable deciding method according to claim 14, further comprising:
an optimum wavelet coefficient value computing step of inputting the selected wavelet coefficient outputted in the output step into a model formula and computing a value of a wavelet coefficient which gives an optimum evaluated value of an evaluation function associated with the model formula; and
an optimum operation variable computing step of performing an inverse wavelet transform for the value of an optimum wavelet coefficient computed in the optimum wavelet coefficient value computing step and computing an optimum operation variable.

16. A variable deciding device for deciding an operation variable to be inputted into a model formula which expresses a batch process to be operated according to an operation variable, comprising:
an input unit for accepting an operation variable after batch process operation; and
a processor capable of executing:
a computation step of computing a wavelet coefficient for an operation variable accepted from the input unit;
a selection step of selecting a wavelet coefficient which satisfies a predetermined condition from wavelet coefficients computed in the computation step; and
an output step of outputting the wavelet coefficient selected in the selection step as a value associated with an operation variable to be inputted into a model formula which expresses a batch process.

17. The variable deciding device according to claim 16, wherein selected in the selection step is a wavelet coefficient, which is computed in the computation step, of a level which is higher than or equal to a predetermined threshold.

18. The variable deciding device according to claim 16, wherein selected in the selection step is a wavelet coefficient, which is computed in the computation step, having an absolute value which is larger than or equal to a predetermined value.

19. The variable deciding device according to claim 16, wherein selected in the selection step is a wavelet coefficient relating to a low-frequency component of a wavelet coefficient, which is computed in the computation step, of a level which is higher than or equal to a predetermined threshold.

20. The variable deciding device according to claim 16, wherein selected in the selection step are all or a part of wavelet coefficients relating to a low-frequency component and a part of wavelet coefficients relating to a high-frequency component of a wavelet coefficient, which is computed in the computation step, of a level which is higher than or equal to a predetermined threshold.

21. The variable deciding device according to claim 16, wherein a wavelet coefficient having an absolute value which is larger than or equal to a predetermined value is selected in the selection step from wavelet coefficients, which are computed in the computation step, of a level which is higher than or equal to a predetermined threshold.

22. The variable deciding device according to claim 16, wherein the processor is capable of further executing:
an optimum wavelet coefficient value computing step of inputting the selected wavelet coefficient outputted in the output step into a model formula and computing a value of a wavelet coefficient which gives an optimum evaluated value of an evaluation function associated with the model formula; and
an optimum operation variable computing step of performing an inverse wavelet transform for the value of an optimum wavelet coefficient computed in the optimum wavelet coefficient value computing step and computing an optimum operation variable.

23. A variable deciding device for deciding an operation variable to be inputted into a model formula which expresses a batch process to be operated according to an operation variable, comprising:
acceptance means for accepting an operation variable after batch process operation from an input unit;
computation means for computing a wavelet coefficient for the operation variable accepted by the acceptance means;
selection means for selecting a wavelet coefficient which satisfies a predetermined condition from wavelet coefficients computed by the computation means; and
output means for outputting the wavelet coefficient selected by the selection means as a value associated with an operation variable to be inputted into a model formula which expresses a batch process.

24. The variable deciding device according to claim 23, wherein the selection means selects a wavelet coefficient, which is computed by the computation means, of a level which is higher than or equal to a predetermined threshold.

25. The variable deciding device according to claim 23, wherein the selection means selects a wavelet coefficient, which is computed by the computation means, having an absolute value which is larger than or equal to a predetermined value.

26. The variable deciding device according to claim 23, wherein the selection means selects a wavelet coefficient relating to a low-frequency component of a wavelet coefficient, which is computed by the computation means, of a level which is higher than or equal to a predetermined threshold.

27. The variable deciding device according to claim 23, wherein the selection means selects all or a part of wavelet coefficients relating to a low-frequency component and a part of wavelet coefficients relating to a high-frequency component of a wavelet coefficient, which is computed by the computation means, of a level which is higher than or equal to a predetermined threshold.

28. The variable deciding device according to claim 23, wherein the selection means selects a wavelet coefficient having an absolute value which is larger than or equal to a predetermined value from wavelet coefficients, which are computed by the computation means, of a level which is higher than or equal to a predetermined threshold.

29. The variable deciding device according to claim 23, further comprising:
optimum wavelet coefficient value computing means for inputting the selected wavelet coefficient outputted by the output means into a model formula and computing a value of a wavelet coefficient which gives an optimum evaluated value of an evaluation function associated with the model formula; and
optimum operation variable computing means for performing an inverse wavelet transform for the value of an optimum wavelet coefficient computed by the optimum wavelet coefficient value computing means and computing an optimum operation variable.

30. A computer-readable recording medium which stores a program for causing a computer to decide an operation variable to be inputted into a model formula which expresses a batch process to be operated according to an operation variable, comprising:
an acceptance step of accepting an operation variable after batch process operation from an input unit;
a computation step of computing a wavelet coefficient for the operation variable accepted in the acceptance step;
a selection step of selecting a wavelet coefficient which satisfies a predetermined condition from wavelet coefficients computed in the computation step; and
an output step of outputting the wavelet coefficient selected in the selection step as a value associated with an operation variable to be inputted into a model formula which expresses a batch process.

31. The recording medium according to claim 30, further comprising:
an optimum wavelet coefficient value computing step of inputting the selected wavelet coefficient outputted in the output step into a model formula and computing a value of a wavelet coefficient which gives an optimum evaluated value of an evaluation function associated with the model formula; and
an optimum operation variable computing step of performing an inverse wavelet transform for the value of an optimum wavelet coefficient computed in the optimum wavelet coefficient value computing step and computing an optimum operation variable.
